(19) United States
(12) Patent Application Publication
(10) Pub. No.: US 2011/0191304 A1
(43) Pub. Date: Aug. 4, 2011

(54) SYSTEM AND METHOD FOR EXPORT AND IMPORT OF METADATA LOCATED IN METADATA REGISTRIES

(75) Inventors: Gerald Ristow, Griesheim (DE); Klaus Schuler, Darmstadt (DE)

(73) Assignee: Software AG, Inc., Darmstadt (DE)

(21) Appl. No.: 12/696,846

(22) Filed: Jan. 29, 2010

(51) Int. Cl. G06F 17/30

(52) U.S. Cl. 707/690; 707/752; 707/802; 707/E17.005; 707/E17.044; 707/705

(57) ABSTRACT

A method for transferring metadata including: separating, using a processor, objects in a metadata registry into system-defined objects and user-defined objects, identifying, using the processor, a consistent set of the user-defined objects to export based on relationships of the user-defined objects with other objects, and exporting, using the processor, the consistent set of user-defined objects. A method for transferring metadata may also include: receiving, using a processor, a consistent set of user-defined objects for import into a metadata registry; and importing, using the processor, the set of user-defined objects into the metadata registry, the importing comprising validating the consistency of the set of user-defined objects.

### BACKGROUND OF THE INVENTION

1. Field of the Invention

The present invention relates generally to a transferring data, and more particularly to systems, methods, and computer-program products for importing and exporting metadata located in metadata registries.

2. Related Art

Service Oriented Architectures typically use a metadata registry to store information on known services. However, a typical setup uses more than one metadata registry. There may be several reasons for using more than one metadata registry, such as, e.g., but not limited to, distinction between development and production environment, enforcing different governance scenarios with distinct registries, or scalability requirements, etc.

When transferring metadata data between metadata registries, typically the entire contents of an originating metadata registry are copied to the destination metadata registry. A full backup of the originating metadata registry is created and the full back up is restored on the destination metadata registry. However, the export and import of a subset of a metadata registry may be desired. The export and import of subsets of a metadata registry is succinctly different from a full backup and restore of the entire registry as only subsets of the contents of the registry are exported and imported.

The export and import of subsets of a metadata registry is non-trivial since the metadata in the registry maintains semantic relations between the objects of the metadata and the graph of these relations is transported as part of the export and import. A metadata registry should not include relationships leading to undefined or missing objects. However, as in many cases all the metadata objects of a metadata registry are inter-related in some fashion, attempting to export a subset of a metadata registry without relationships leading to undefined or missing objects will lead to a full backup. U.S. Patent Publication No. 2009/0024561 describes the export, canonical representation, and import of subsets of data corresponding to service metadata. However, the method of U.S. Patent Publication No. 2009/0024561 is specialized to export service metadata and does not provide for the export of other types of metadata or generic metadata.

Accordingly, there is a need for a system and method that can overcome the disadvantages of previous systems and methods.

### SUMMARY OF THE INVENTION

In an illustrative embodiment of the present invention, a method and computer readable medium is disclosed. According to one embodiment, a method for transferring metadata may be provided. The method may comprise: separating, using a processor, objects in a metadata registry into system-defined objects and user-defined objects, identifying, using the processor, a consistent set of the user-defined objects to export based on relationships of the user-defined objects with other objects, and exporting, using the processor, the consistent set of user-defined objects.

According to another embodiment, a method for transferring metadata may comprise: receiving, using a processor, a consistent set of user-defined objects for import into a metadata registry, and importing, using the processor, the set of user-defined objects into the metadata registry, the importing comprising validating the consistency of the set of user-defined objects.

According to another embodiment, a method for transferring metadata may comprise: providing a generic function for exporting a metadata object in a consistent set of one or more metadata objects based on an object type of the metadata object.

According to another embodiment, a computer readable medium storing computer readable program code for causing a computer to perform a method for transferring metadata may be provided. The method may comprise separating, using a processor, objects in a metadata registry into system-defined objects and user-defined objects, identifying, using the processor, a consistent set of the user-defined objects to export based on relationships of the user-defined objects with other objects, and exporting, using the processor, the consistent set of user-defined objects.

According to another embodiment, a computer readable medium storing computer readable program code for causing a computer to perform a method for transferring metadata may comprise: receiving, using a processor, a consistent set of user-defined objects for import into a metadata registry, and importing, using the processor, the set of user-defined objects into the metadata registry, the importing comprising validating the consistency of the set of user-defined objects.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 illustrates an exemplary relationship diagram of set of objects according to an exemplary embodiment of the present invention;

FIG. 2 illustrates an exemplary relationship diagram of a set of objects identifying system-defined objects according to an exemplary embodiment of the present invention;

FIG. 3 illustrates an exemplary relationship diagram of a set of objects identifying system-defined objects and sets of user-defined objects according to an exemplary embodiment of the present invention;

FIG. 4 illustrates an exemplary relationship diagram of the sets of object of FIG. 3 separated and imported into two independent metadata registries according to an exemplary embodiment of the present invention;

FIG. 5 illustrates an exemplary embodiment of a relationship diagram of a first user-defined set dependent on a second user-defined set;

FIG. 6 illustrates an exemplary embodiment of a relationship diagram of a first and third user-defined sets dependent on a second user-defined set;

FIG. 7 illustrates an exemplary embodiment of a relationship diagram of the first, second, and third user-defined sets of FIG. 6 imported into independent metadata registries;

FIG. 8 illustrates an exemplary flowchart process of exporting one or more objects according to an exemplary embodiment of the present invention;

FIG. 9 illustrates an exemplary flowchart process of a default export plug-in according to an exemplary embodiment of the present invention;

FIG. 10 illustrates an exemplary flowchart process of importing one or more objects according to an exemplary embodiment of the present invention;

FIG. 11 illustrates an exemplary flowchart process of a default import plug-in according to an exemplary embodiment of the present invention; and

FIG. 12 illustrates an exemplary computer according to an exemplary embodiment of the present invention.

### DETAILED DESCRIPTION OF THE INVENTION

While a service-oriented architecture (SOA) metadata registry using the JAXR standard is discussed below, it should be understood that the invention is not limited to only a (SOA) metadata registry using the JAXR standard and can be equally applied to transfer a set of relational objects between other types of databases.

A typical implementation of a metadata registry uses the JAXR standard. The JAXR standard provides a uniform and standard Java API for accessing different kinds of XML-based metadata registry. In particular, JAXR defines the following object types: Organization, User, Services, Generic registry objects, Classifications, Associations, Auditable Events, External Link, Concepts, and Classification scheme.

A metadata registry may also offer additional functionality, such as, e.g., but not limited to, definition of user-defined types and user-defined type classifications, lifecycle management of registry objects, and governance for services stored in the registry.

To provide the added functionality, the standard JAXR data model may be extended with additional functionality, such as, e.g., but not limited to, allow registry objects having a lifecycle with an associated lifecycle model, including governance functionality with the creation of a new object type, or allowing security functionality. The new object type with governance functionality included may be Policies. A policy may be modeled as a graph of associated registry objects. Security functionality may permit a security model with users, roles, groups, permissions.

Additionally, metadata for the additional functionality may comprise classification and hierarchy metadata of types, lifecycle model metadata, and governance policies with their related security objects users, roles, groups, permissions.

These enhancements of the JAXR data model may pose a new challenge when exporting and importing metadata objects in a registry corresponding to these enhancements of the JAXR data model. The enhancements of the functionality may be implemented as a number of inter-connected registry objects. When seeking to export these registry objects, the integrity of the exported metadata should be still be maintained. Integrity of metadata may be maintained by exporting all objects connected with any one object to be exported. However, the export of these inter-connected registry objects may not be simply done by determining the graph of all connected objects as this may result in the export of the complete registry, as all objects in the registry may be ultimately connected, whether indirectly or directly. Any export may degenerate into the pathological case resulting in a complete backup of the registry. Accordingly, ensuring all metadata needed for an export is included in a transfer may collide with avoiding a full export of the whole registry.

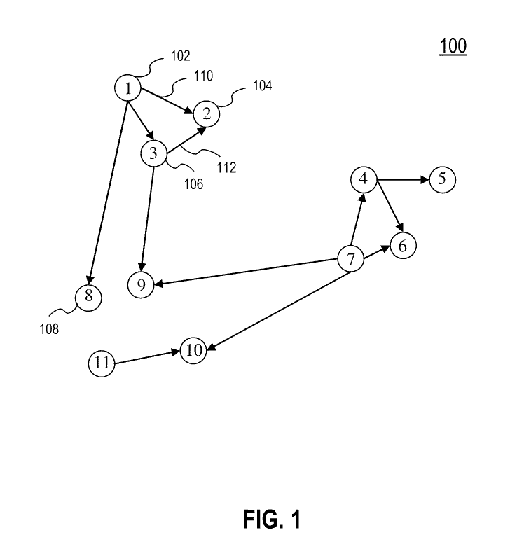

FIG. 1 illustrates an exemplary embodiment of a relationship diagram of set of objects 100. The objects of a metadata registry form a graph of inter-connected registry objects, see FIG. 1. In the exemplary embodiment, a metadata registry typically contains objects 102, 104, 106, and 108. Objects may be user-defined or system-defined data representing metadata of physical objects, such as, e.g., but not limited to, service implementations, application server or computing nodes, etc. The set of objects include a number of objects labelled 1-11, 102 is labelled “1”, 104 is labelled “2”, 106 is labelled “3” and 108 is labelled “8.” The set of objects also includes additional objects labelled 4-7 and 9-11.

The relationship diagram 100 also includes references 110 and 112 between the objects. These references represent relationships between various objects. Reference 110 represents that Object 1, 102, references Object 2, 104. Reference 112 represents that Object 3, 106, references Object 2, 104. The relationship diagram 100 also includes other references.

The objects may reference only other objects, such as, e.g., but not limited to, the Object 1 which references the objects labelled “2”, “3”, and “8.” The objects may be only referenced by other objects, such as, e.g., but not limited to, Object 8 referenced by Object 1. The objects may also both reference other objects and be referenced by other objects, such as, e.g., but not limited to Object 3 which is referenced by Object 1 and references Object 2. The objects may reference any number of objects and be referenced by any number of objects.

As can be seen in FIG. 1, every object in the relationship diagram directly or indirectly has a relationship with the other objects of FIG. 1. Furthermore, the set is a consistent set, also called a closed set, as all of the relationships end with a defined object. An inconsistent set may be a set including a reference that either comes from or leads to an undefined object. An inconsistent set may be problematic as objects may not be properly defined if they are related to objects that are undefined. Thus, as all the objects of FIG. 1 are related to all the other objects, conventionally to avoid inconsistencies, the entire set of objects is transferred when the data of any object is desired to be transferred.

To enable the export of a subset of a metadata registry, an export set comprising a subset of the objects of the metadata registry may be determined Determining an export set may be a non-trivial task since not all objects of the registry should be exported in any given export set, but at the same time consistency when importing the export set into another metadata registry should be assured. Thus, determining the export set includes traversing of the graph to identify objects to include in the export set. The correct export set for exporting each type of metadata may be determined based on the metadata type of the metadata objects being transferred.

A metadata type can be represented internally by a set of registry objects which may have different registry object types. For example, a policy may have the metadata type policy which may be represented by a number of registry objects with a number of different types, such as, e.g., but not limited to, policy parameter type and policy return type. Determination of an export set may rely on definitions of types of objects.

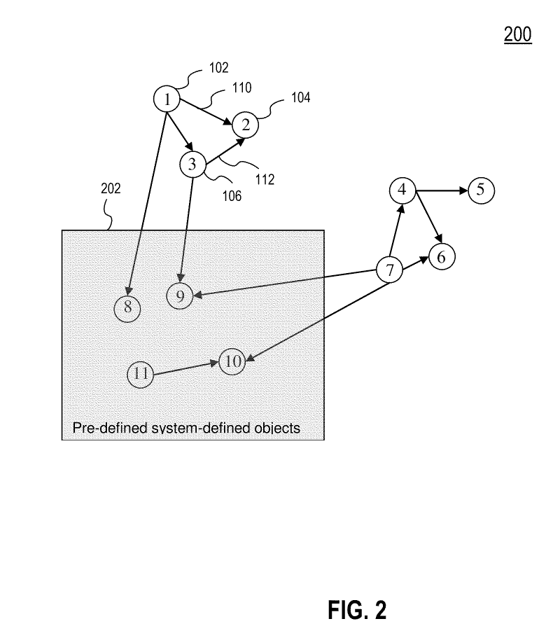

FIG. 2 illustrates an exemplary embodiment of a relationship diagram 200 of a set of objects identifying system-defined objects. In the exemplary embodiment, a set of objects is separated into system-defined objects and user defined objects. The system-defined objects are represented by objects 8-11 within box 202. The user-defined objects are represented by objects 1-7 outside of the box 202.

System-defined objects may be pre-defined objects pre-defined by the system. The system-defined objects may be common pre-defined objects on metadata registries, such as, e.g., but not limited to, policy, lifecycle model, or security objects. User-defined objects may be metadata objects defined by a user that are not common to other metadata registries. User-defined objects may allow the metadata registry to be extended beyond system definitions and permit customization of the metadata registry for customized purposes.

Each object may be associated with an indicator which indicates if the object is a system-defined object or a user-defined object. Whenever a user creates a new object or modifies a system-defined object, the indicator associated with the resulting object may indicate that the object is a user-defined object.

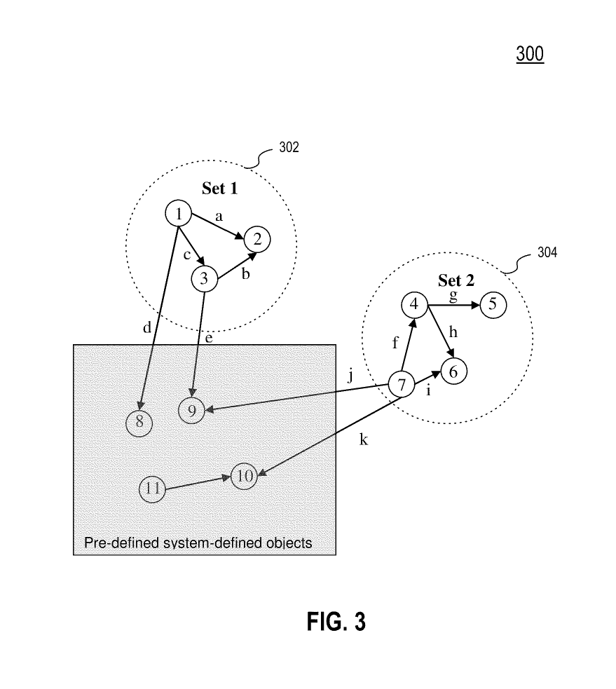

FIG. 3 illustrates an exemplary embodiment of a relationship diagram 300 of a set of objects identifying system-defined objects and sets of user-defined objects. In an exemplary embodiment, user-defined objects may be separated into their own sets. These sets can represent different organizational units, separation between object types and object instances, separation between classifications and objects, or separation between objects and rules being applied to them (policies). In FIG. 3, the objects labeled 1-3 may belong to a first set 302, labeled “Set 1.” Set 1 may represent one organizational unit. The objects labeled 4-7 may belong to a second set 304, labelled “Set 2.” Set 2 may represent another organizational unit.

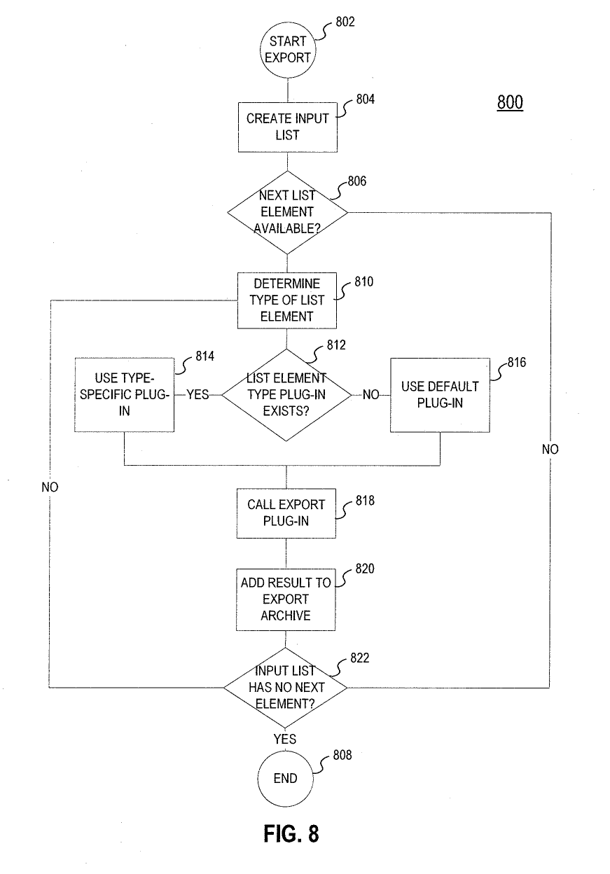

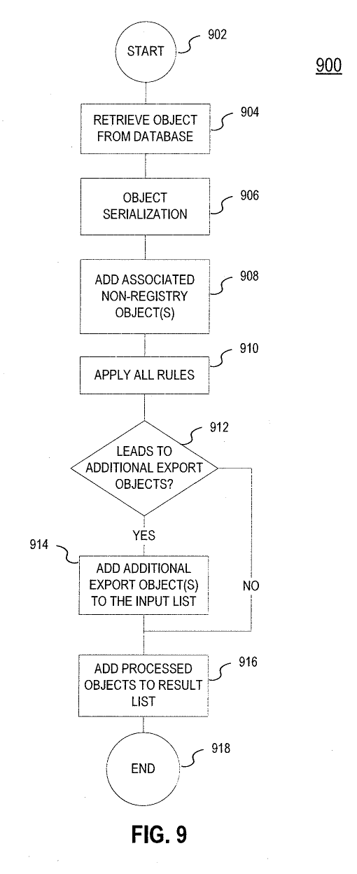

Sets of user-defined objects may be determined using a number of methods. In an exemplary embodiment, a set of user-defined objects may be determined based on objects identified by a user to belong to a set. In another exemplary embodiment, a set of user-defined objects may be determined based on objects identified in the metadata registry to belong to a set. In yet another exemplary embodiment, a set of user-defined objects may be determined based on a rule for exporting the user-defined object. The rule for exporting the user-defined object may be based on an object type of the user-defined object, where every object type has an associated export rule identifying objects to include and/or exclude when exporting. The determination of an export set is further described below in reference to FIGS. 8 and 9.

When transferring the metadata of Set 1, the export set for Set 1 may include objects 1, 2 and 3 and the relationships a, b, c, d and e. In a similar fashion, when transferring the metadata of Set 2, the export set for Set 2 may include objects 4, 5, 6 and 7 and the relationships f, g, h, i, j and k. Although both Set 1 and Set 2 include relationships that point to objects that are not within the sets, d and e for Set 1, which reference system-defined objects 8 and 9, respectively, and j and k for Set 2, which reference system-defined objects 9 and 10, respectively, the sets may still be considered closed sets as the sets may be imported to metadata registries which already have existing system-defined metadata objects corresponding to those related objects not found within the set.

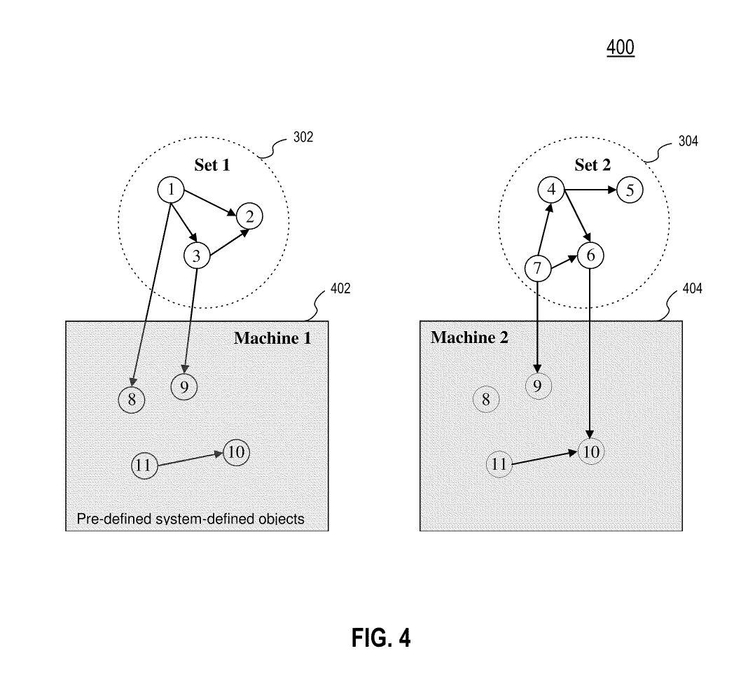

A use case for exporting Set 1 and Set 2 may be to separate the metadata belonging to two different organizational units or groups. FIG. 4 illustrates an exemplary relationship diagram 400 of Set 1, 302, and Set 2, 304, of FIG. 3 separated and imported into two independent machines 402 and 404 according to an exemplary embodiment of the present invention.

According to an embodiment, machines 402 and 404 may include identical metadata registries which have the same set of pre-defined system-defined objects as the metadata registry Set 1 and Set 2 were exported from. Set 1, 302, may be imported into Machine 1, 402, and Set 2, 304, may be imported into Machine 2, 404. As shown in the relationship diagram 400, different subsets of a metadata registry may be imported into other different metadata registries.

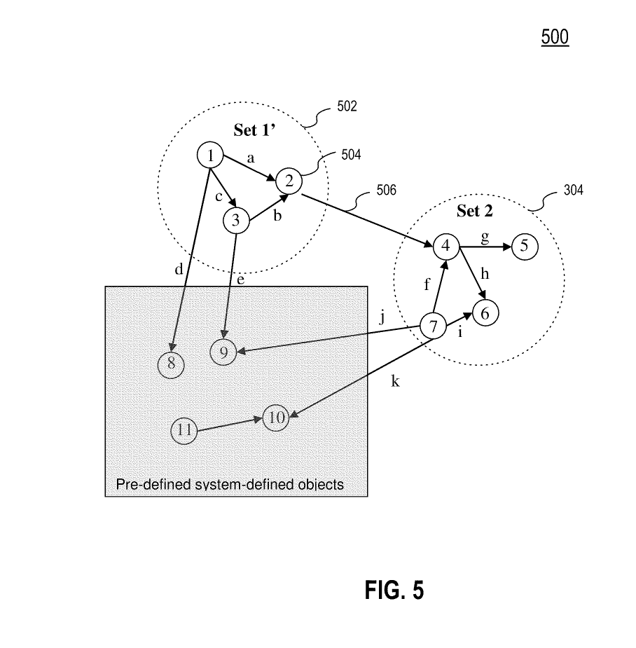

FIG. 5 illustrates an exemplary embodiment of a relationship diagram 500 of a first user-defined set 502 dependent on a second user-defined set 304. A set of user-defined objects may be considered dependent if an object of the set references a user-defined object not within the set. Correspondingly, a set of user-defined objects may be considered an independent set if none of the objects of the set references a user-defined object not within the set.

The first user-defined set 502 may be labelled Set 1′ and the second user-defined set 304 may be labelled Set 2. Set 2 may be identical to Set 2 of the previous Figures. Set 1′ may vary from to Set 1 as previously appearing in that object 2, 504, of Set 1′ may include a reference 506 to object 4 of Set 2.

A common scenario for a user-defined set dependent on another user-defined set may include when company standards define user-defined types, classifications, or policies that are distributed throughout the organization, and additional metadata objects reference these user-defined types, classifications, or policies.

When Set 2′ is exported, the metadata registry creates an export archive with information for another metadata registry to import Set 2′. The export archive for Set 2 may be the same as the export archive for Set 2 shown in FIG. 3. The archives may be the same because although object 2 of Set 1′ is dependent on object 4 of Set 2 of FIG. 5, the objects within Set 2 of FIG. 5 have the same dependencies as the objects of Set 2 of FIG. 3.

However, when Set 1′ is exported, the export archive for Set 1′ may contain more objects than that of the previously discussed export of Set 1. The export archive for Set 1′ may contain more objects than the export archive of Set 1 because Set 1′ is dependent on Set 2, which comprises user-defined objects. Thus, when exporting Set 1′, Set 2 may need to also be exported. Set 1′ may be transformed into an independent set if the objects and relationships of Set 2, which are referenced directly and indirectly from Set 1′, are added to Set 1′, along with relationship 506. However, to avoid overlap, when exporting Set 1′, Set 1′ may be exported as a dependent set as shown in Set 1′, including relationship 506 to Set 2, and Set 2 may be exported as a separate independent set within the export archive.

When importing the metadata objects, a specific order of importing the objects may be followed to assure no dangling or unsatisfied references are created. Dangling or unsatisfied references may be relationships of objects that link with objects that are undefined. The creation of dangling or unsatisfied references in a metadata registry may be prohibited by the import mechanism. When a dangling or unsatisfied reference may be created during an importation of an object, the process may abort the importation of an object, a set of objects, or an entire archive. To avoid dangling or unsatisfied references, a specific order for importation may be used. For example, object types may be imported before importing any instances of the object type. As another example, security objects of a registry object may be integrated into the security runtime after all registry objects are imported.

When importing Set 1′ and Set 2 as shown in FIG. 3, Set 2 may be imported before Set 1′ to ensure all referenced objects in the sets are known during the importation process of each set. If Set 1′ were imported before Set 2, the importation process may determine that Set 1′ is not a consistent or closed set because object 2 of Set 1′ references object 4 of Set 2, which may not have been imported yet. An example of importing an independent set before a set dependent on the independent set may be when importing user-defined objects that reference user-defined types, classifications and policies. In this example, the user-defined types, classifications and policies may need to be imported before the referencing user-defined objects.

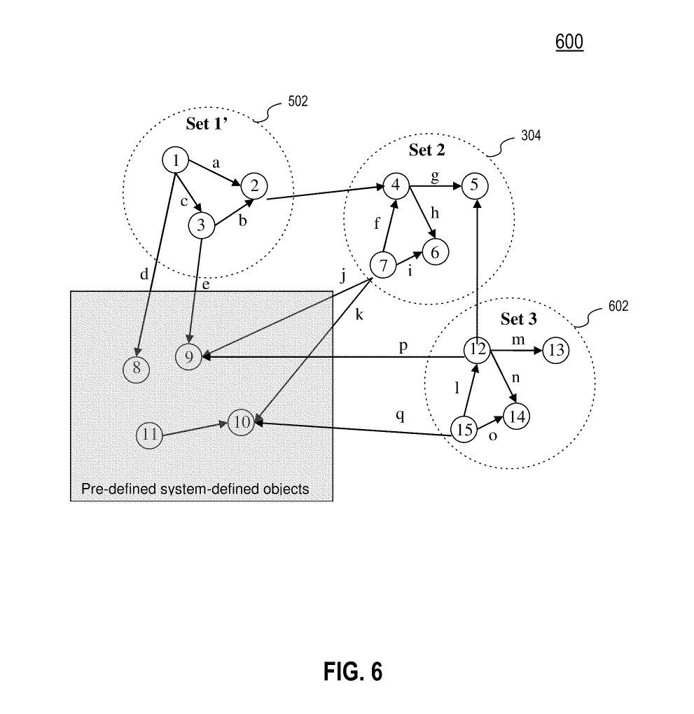

FIG. 6 illustrates an exemplary embodiment of a relationship diagram 600 of a first 502 and third 604 user-defined set dependent on a second 304 user-defined set. The first set 502 is labelled Set 1′ and may be the same as Set 1′ in FIG. 5. The third set 604 is labelled Set 3. The second set 304 is labelled Set 2 and may be the same Set 2 as appears in FIG. 3. The first set 502 depends from the second set 304, and the third set 602 also depends from the second set 304, but neither the first set 502 nor the third set 602 depend from one another.

If data in the metadata registry is divided up into independent and dependent sets, it may be simple to distribute the data onto multiple registries. Additional registries may be needed by an organization as the organization changes or grows. As an example, the second set 304 may include company standards which define user-defined types, classifications and policies. The first set 502 and third set 602 may include data based on the user-defined types, classifications and policies. Thus, when creating a new registry, the second set 304 may be imported first before the first set 502 and the third set 602 are imported. By providing the second set 304 as a separate set, if company standards change or are extended, the company standards stored in the second set 304 can be reloaded by overwriting the second set 304 without affecting data stored in the first set 502 and the third set 602.

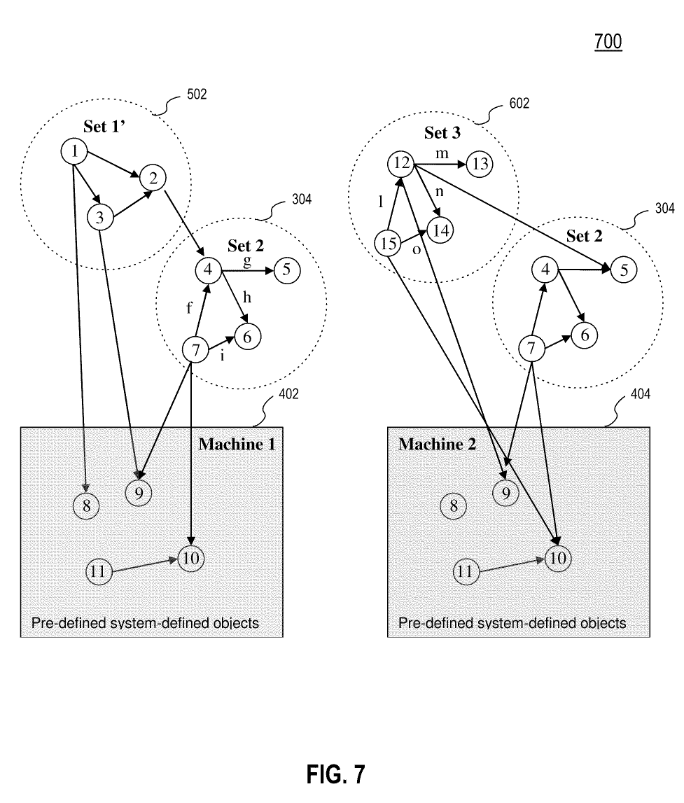

FIG. 7 illustrates an exemplary embodiment of a relationship diagram of the first user-defined set 502, second user-defined set 304, and third user-defined set 602 of FIG. 6 imported into independent metadata registries on independent machines. The first user-defined set 502 may be imported into Machine 1 402 and the third user-defined set 602 may be imported into Machine 2 404. As the first 502 and third 602 user-defined sets both depend from the second user-defined 304, the second user-defined set 304 may be imported into both Machine 1 and Machine 2 first in order to ensure the first user-defined set 502 may be imported into Machine 1 and the third user-defined set 602 may be imported into Machine 2.

FIG. 8 illustrates an exemplary flowchart 800 process of exporting one or more objects according to an exemplary embodiment of the present invention. Process 800 may depict a generic process for exporting that may be applied to export any metadata object belonging to a metadata registry, or to export relational objects belonging to other types of databases. According to an embodiment, the flowchart 800 may begin with 802 and immediately continue to 804.

In 804, the process may create an input list 804 of elements representing metadata objects to be exported. The input list may be a list of metadata objects selected by the user for export, and may also include metadata objects added by the process to include with the metadata objects to maintain integrity of the export set. According to an embodiment, each metadata object may have an associated export function defined using which the metadata object may export the metadata object. The associated export functions may all be referenced using a generic function that serves as an interface to the associated export functions. From 804, flowchart 800 may continue with 806.

In 806, the process may determine if the next list element in the input list is available. A next list element may be available if the list is not exhausted. If the next list element is not available, the flowchart 800 may continue to 808 and end. Alternatively, if the next list element is available, flowchart 800 may continue to 810.

In 810, the process may determine the type of the list element. The process may determine the type of the list element based on type classification data associated with the object corresponding to the list element. From 810, flowchart 800 may continue with 812. In 812, the process may determine if the list element type has an existing plug-in. The process may query a database for plug-ins associated with the list element type. If a plug-in for the list element type does exist, flowchart 800 may continue with 814. In 814, the plug-in of the list element type is selected as the export plug-in to be used for exporting the list element. From 814, flowchart 800 may continue with 818.

Returning to 812, alternatively if a plug-in for the list element type does not exist, flowchart 800 may continue with 816. In 816, a default plug-in may be selected as the export plug-in to be used for exporting the list element. From 816, flowchart 800 may also continue with 818.

In 818, the process may call the selected export plug-in. The export plug-in may return results for creating an export archive. The results may be information for transfer of the list element. The export archive may be the complete archive of all the information for the transfer of the entire export process. The function and operation of the export plug-in is further described below in FIG. 9. From 818, flowchart 800 may continue with 820.

In 820, the results from calling the export plug-in may be added to the export archive. From 820, flowchart 800 may continue with 822.

In 822, flowchart 800 may determine if the input list has no next element. If the input list does have a next list element, flowchart 800 may return to 810. Alternatively, if the input list does not have a next list element, flowchart 800 may continue with 808 and end.

FIG. 9 illustrates an exemplary flowchart process of a default export plug-in according to an exemplary embodiment of the present invention. According to an exemplary embodiment, flowchart 900 may begin with 902 and immediately continue with 904. In 904, the process may retrieve one object from the database. The process may retrieve the object based on an identifier of the object in the list element.

From 904, flowchart 900 may continue with 906. In 906, the one or more objects retrieved from the database may undergo object serialization. In an embodiment, Extensible Markup Language (XML) may be used as a serialization format. During object serialization, the one or more objects may be processed into a data format suitable for export to another metadata registry.

From 906, flowchart 900 may continue with 908. In 908, any associated non-registry objects may be added to a result list. Associated non-registry objects may be objects, such as, e.g., but not limited to, icons, design documents, schema definition, etc., associated with the metadata object. The associated non-registry objects may be stored in a repository part of the registry and referenced from the metadata object. The associated non-registry objects may be found through references in metadata objects. The result list may be a list of data returned as a result to the process shown in 818 of flowchart 800.

From 908, flowchart 900 may continue with 910. From 910, rules may be applied. Rules may lead to additional actions to be performed, such as, e.g., but not limited to, when exporting an instance of a user-defined type, the user-defined type definition is included in the export, or when exporting a registry object, also include one or more security objects. Additionally, a rule may identify additional objects to be exported when exporting the list element. The rules may not only identify objects which are system-defined and should not be exported, but may also ensure the integrity of the metadata by identifying additional objects needed to be exported with a list element to maintain the consistency of an export set. These additional objects may be exported along with the list element to ensure the export set is a consistent set.

From 910, flowchart 900 may continue with 912. In 912, the process may determine if any additional export objects have been identified in 910. If the process determines there is one or more additional export objects, flowchart 900 may continue with 914. In 914, the one or more additional export objects may be added to the input list. From 914, flowchart 900 may continue with 916.

Returning to 912, if the process determines there are not any additional export objects, flowchart 900 may also continue with 916.

In 916, the process may add the processed objects to the results list. The processed results may include the serialized objects and the associated non-registry objects. From 916, flowchart 900 may continue to 918 and process may end with the result list returned as a result from the export plug-in.

In one exemplary embodiment, applying rules as described in 910 may be a recursive method. Sets may be considered consistent if all the objects of the set are only related to other objects of the set or system-defined objects. The method may begin with defining a set including a single object to be exported. The method may then determine the objects directly related to any object in the set. If any related object is a system-defined object, the system-defined object is not added to the set. If any related object is a user-defined object, the user-defined object is added to the set. The method may then determine the objects directly related to any object in the updated set and repeatedly add objects to the set until the only objects outside of the set directly related to objects in the set are system-defined objects.

As an example using the relationship diagram of FIG. 3, when exporting Object 1, the method may begin with a set including only Object 1. The method may then determine the objects directly related to Object 1, which would be Object 2 by relationship a and Object 3 by relationship c. The method may determine Objects 2 and 3 are not system-defined objects and add the objects to the export set. The method may also determine that Object 8 related to Object 1 by d is a system-defined object and should not be added to the export set. The method may then identify if Objects 1, 2, and 3 are directly related to objects not in the set and which are not system-defined objects. If identification is negative, the method may determine that Objects 1, 2, and 3 define consistent set 1.

According to an embodiment, an export strategy may be different for every type of registry object in a metadata registry. However, there may be a uniform way to determine the export set for any given registry object type. To support the uniform process, a JAXR API may define an interface which every registry object type may satisfy and implement. The uniform process may follow the process shown in FIG. 8. The export interface may return the registry objects to be exported in conjunction with an instance of a particular registry object type. The export interface may also only return a set and prevent duplicates of the same object. Duplicates may be prevented by identifying objects with the same identifier unique to each object, and removing all but one of each object of a particular unique identifier. Additionally, the export interface may determine the correct implementation for exporting each registry object type during export, the correct implementation may be represented by an export plug-in for the object type, which may follow the process as shown in FIG. 9.

Additionally, each export archive may include a manifest file with it. The manifest file may include version information such that the compatibility level of export and import metadata registries can be verified. Verification may be determined based on if the version information of the manifest file of the export set is compatible with the metadata registry the export set will be imported into. In an embodiment, verification may be comparing the version number from the manifest file in an export archive to the version number of the importing registry. Verification based on compatibility level may ensure that the content of the source and target registry are compatible in terms of the system-defined content such that system-defined objects may be omitted from the export set.

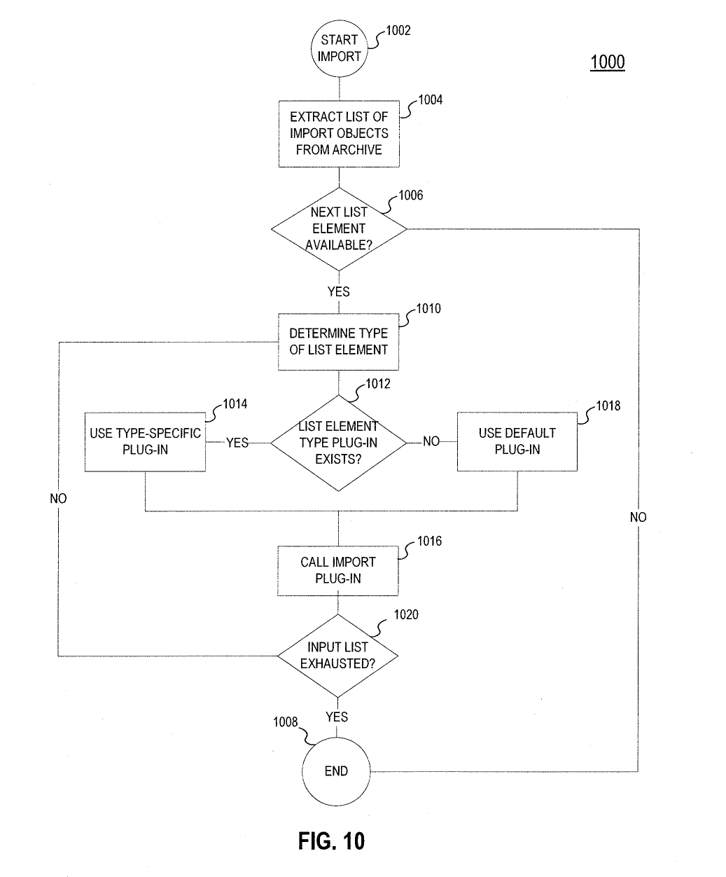

FIG. 10 illustrates an exemplary flowchart 1000 process of importing one or more objects according to an exemplary embodiment of the present invention. According to an exemplary embodiment, the import process may import metadata objects from an export archive into a metadata registry. Flowchart 1000 may begin with 1002 and immediately continue with 1004. In 1004, process may extract a list of import objects from an archive. The archive may be an export archive generated by the export process described above in FIGS. 8 and 9.

From 1004, flowchart 1000 may continue with 1006. In 1006, the process may determine if the next element in the list is available. For the import process, the elements of the list may be objects to be imported. If the next list element is not available, flowchart 1000 may continue with 1008 and end. The next list element may be unavailable if the list is exhausted. Alternatively, if the next list element is available, flowchart 1000 may continue with 1010.

In 1010, the process may determine the type of the list element. Determining the type of the list element may be determining the type of the metadata corresponding to the list element. The process may determine the type of the list element based on information stored in the archive indicating the type of an object.

From 1010, flowchart 1000 may continue with 1012. In 1012, the process may determine if a import plug-in for the list element exists. According to an embodiment, the determining process may be similar to determining if an export plug-in for a list element type exists. If a import plug-in for the list element type does exist, flowchart 1000 may continue with 1014. In 1014, the plug-in for the list element type is selected as the import plug-in for importing the list element. From 1014, flowchart 1000 may continue with 1016.

Returning to 1012, if a plug-in for the list element type does not exist, flowchart 1000 may continue with 1018. In 1018, the default import plug-in may be selected as the import plug-in for importing the list element. From 1018, flowchart 1000 may also continue with 1016.

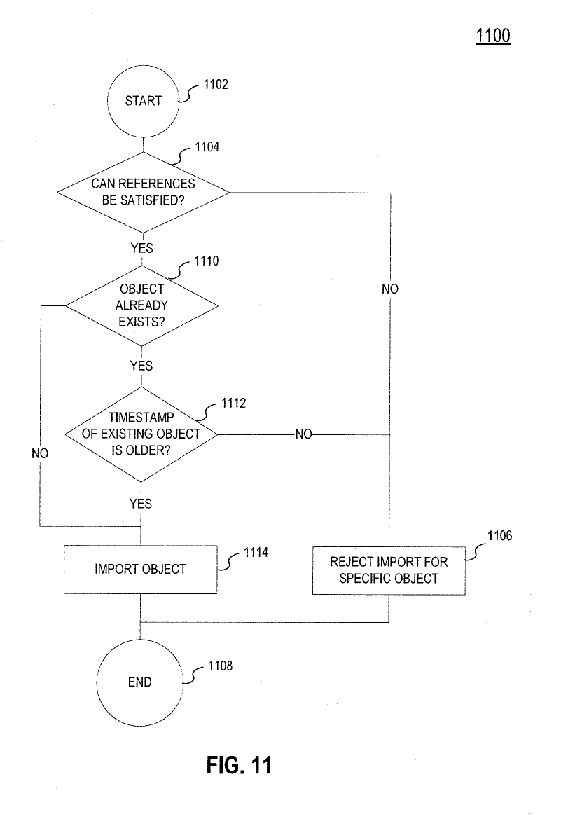

In 1016, the process may call the selected import plug-in. The import plug-in may import the list into the metadata registry and is further described below in reference to FIG. 11. From 1016, flowchart 1000 may continue with 1020.

In 1020, the process may determine if the input list is exhausted. The input list may be exhausted if every list element of the extracted list of import objects from the archive has been processed. From 1020, flowchart 1000 may continue with 1008 and end.

FIG. 11 illustrates an exemplary flowchart 1100 process of a default import plug-in according to an exemplary embodiment of the present invention. According to an embodiment, the process of flowchart 1100 may be called upon in 716. The process may import a list element into a metadata registry. Flowchart 1100 may begin with 1102 and immediately continue with 1104.

In 1104, the process may determine if references can be satisfied when importing the object. References may be the relationships of the object being imported. The process may determine if all references can be satisfied based on determining if all the references pointing outward from the object point to objects that exist within the metadata registry or objects that exist within the import archive.

If the references can not be satisfied, flowchart 1100 may continue with 1106. In 1106, the process may reject importation of the object. From 1106, flowchart 1100 may continue with 1108 and end.

Returning to 1104, if the process determines the references are satisfied, flowchart 1100 may continue with 1110. In 1110, the process may determine if the object to be imported already exists within the metadata registry. If the object does not already exist in the metadata registry, flowchart 1100 may continue with 1114.

Returning to 1110, if the object already exists in the metadata registry, flowchart 1100 may continue with 1112. In 1112, the process may determine if the timestamp of the existing object in the metadata registry is older than the timestamp of the object in the archive. If the timestamp of the existing object is older, flowchart 1100 may continue with 1114. Alternatively, if the timestamp of the existing object is not older, flowchart 1100 may continue with 1106. Overwrite of the timestamp behaviour may be possible, such as, e.g., but not limited to, importing objects that have timestamps smaller than timestamps of existing objects.

In 1114, the object may be imported into the metadata registry. From 1114, the process may continue with 1108 and end.

For the import process, depending on the type of the metadata objects in an export set, different actions may be performed to import different types of objects. However, similarly to the export process, there may be a uniform way to import the different types of objects.

As discussed above, exporting a set of metadata may be done through a generic function that serves as an interface to specific export functions associated with each object type. In an embodiment, the generic function may be an application programming interface (API) that may provide the generic function. According to an embodiment, a JAXR API may define an import interface every registry object type may satisfy and implement. The uniform method for importing may be the process shown in FIG. 10, and the method for importing each type of object may be the process shown in FIG. 11.

Since the export set may include a manifest file including version information of the export metadata registry, the import interface may first verify the compatibility of the export set with the import metadata registry before importing any objects. If the version information of the export registry does not match, the entire export set may be rejected. In an embodiment, matching may mean the version information of the manifest file and import metadata registry correspond to the same version.

The import interface may check whether the instance of the registry object validates with the corresponding type of the registry object. Each registry object may have a specific object type. In validating, the object type of the object in the import set may be compared with the object type of the object in the importing registry.

If the object to be imported is part of the runtime system of the metadata registry, the import process may ensure that the object is registered with the runtime system before permitting the object be imported into the registry. Objects belonging to the governance runtime and the security runtime may be part of the runtime system of the metadata registry.

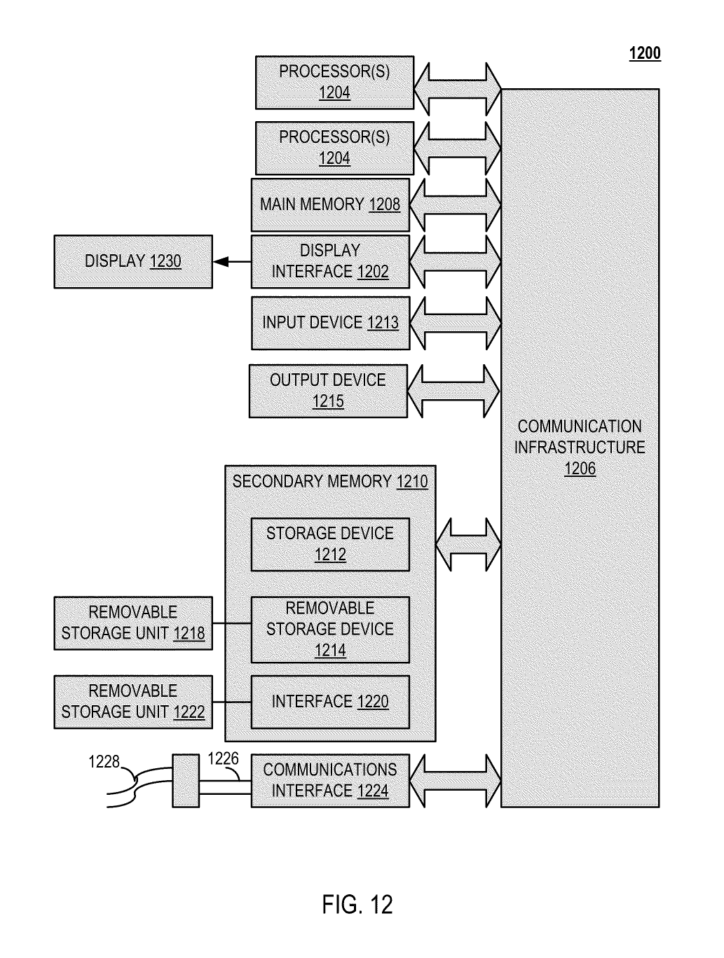

FIG. 12 depicts an illustrative computer system that may be used in implementing an illustrative embodiment of the present invention. Specifically, FIG. 12 depicts an illustrative embodiment of a computer system 1200 that may be used in computing devices such as, e.g., but not limited to, standalone or client or server devices. FIG. 12 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 1200 is shown in FIG. 12, depicting an illustrative embodiment of a block diagram of an illustrative computer system useful for implementing the present invention. Specifically, FIG. 12 illustrates an example computer 1200, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 1200 is shown in FIG. 12. Other components of the invention, such as, e.g., (but not limited to) a computing device, a communications device, a telephone, a personal digital assistant (PDA), a personal computer (PC), a handheld PC, a laptop computer, a netbook, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 12.

The computer system 1200 may include one or more processors, such as, e.g., but not limited to, processor(s) 1204. The processor(s) 1204 may be connected to a communication infrastructure 1206 (e.g., but not limited to, a communications bus, cross-over bar, interconnect, or network, etc.). Processor 1204 may include any type of processor, microprocessor, or processing logic that may interpret and execute instructions (e.g., for example, a field programmable gate array (FPGA)). Processor 1204 may comprise a single device (e.g., for example, a single core) and/or a group of devices (e.g., multi-core). The processor 1204 may include logic configured to execute computer-executable instructions configured to implement one or more embodiments. The instructions may reside in main memory 1208 or secondary memory 1210. Processors 1204 may also include multiple independent cores, such as a dual-core processor or a multi-core processor. Processors 1204 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 1200 may include a display interface 1202 that may forward, e.g., but not limited to, graphics, text, and other data, etc., from the communication infrastructure 1206 (or from a frame buffer, etc., not shown) for display on the display unit 1230.

The computer system 1200 may also include, e.g., but is not limited to, a main memory 1208, random access memory (RAM), and a secondary memory 1210, etc. Main memory 1208, random access memory (RAM), and a secondary memory 1210, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 1210 may include, for example, (but is not limited to) a hard disk drive 1212 and/or a removable storage drive 1214, representing a floppy diskette drive, a magnetic tape drive, an optical disk drive, a compact disk drive CD-ROM, etc. The removable storage drive 1214 may, e.g., but is not limited to, read from and/or write to a removable storage unit 1218 in a well known manner. Removable storage unit 1218, also called a program storage device or a computer program product, may represent, e.g., but is not limited to, a floppy disk, magnetic tape, optical disk, compact disk, etc. which may be read from and written to removable storage drive 1214. As will be appreciated, the removable storage unit 1218 may include a computer usable storage medium having stored therein computer software and/or data.

In alternative illustrative embodiments, secondary memory 1210 may include other similar devices for allowing computer programs or other instructions to be loaded into computer system 1200. Such devices may include, for example, a removable storage unit 1222 and an interface 1220. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1222 and interfaces 1220, which may allow software and data to be transferred from the removable storage unit 1222 to computer system 1200.

Computer 1200 may also include an input device 1213 may include any mechanism or combination of mechanisms that may permit information to be input into computer system 1200 from, e.g., a user. Input device 1213 may include logic configured to receive information for computer system 21000 from, e.g. a user. Examples of input device 1213 may include, e.g., but not limited to, a mouse, pen-based pointing device, or other pointing device such as a digitizer, a touch sensitive display device, and/or a keyboard or other data entry device (none of which are labeled). Other input devices 1213 may include, e.g., but not limited to, a biometric input device, a video source, an audio source, a microphone, a web cam, a video camera, and/or other camera.

Computer 1200 may also include output devices 1215 which may include any mechanism or combination of mechanisms that may output information from computer system 1200. Output device 1215 may include logic configured to output information from computer system 1200. Embodiments of output device 1215 may include, e.g., but not limited to, display 1230, and display interface 1202, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 1200 may include input/output (I/O) devices such as, e.g., (but not limited to) communications interface 1224, cable 1228 and communications path 1226, etc. These devices may include, e.g., but are not limited to, a network interface card, and modems (neither are labeled).

Communications interface 1224 may allow software and data to be transferred between computer system 1200 and external devices.

Finally, while various exemplary embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for transferring metadata comprising:
separating, using a processor, objects in a metadata registry into system-defined objects and user-defined objects;
identifying, using the processor, a consistent set of the user-defined objects to export based on relationships of the user-defined objects with other objects; and
exporting, using the processor, the consistent set of user-defined objects.

2. The method of claim 1, wherein said identifying comprises:
determining the object type of a user-defined object;
determining a rule for exporting the user-defined object based on the determined object type; and
selecting user-defined objects to export related to the user-defined object based on the rule.

3. The method of claim 2, wherein said identifying comprises:
selecting user-defined objects to export indirectly related to the user-defined object based on the rule.

4. The method of claim 2, wherein the rule comprises:
a definition for selecting user-defined objects to export related to the user-defined object, the definition corresponding to the object type of the user-defined object.

5. The method of claim 1, wherein said separating objects comprises:
associating data indicating the system-defined objects are objects including information shared by a second metadata registry; and
associating data indicating the user-defined objects are objects including information not shared by the second metadata registry.

6. The method of claim 1, further comprising:
receiving, using the processor, a request to export a subset of the objects.

7. The method of claim 1, further comprising:
providing a generic function for exporting objects of any type, wherein said identifying the consistent set of the user-defined objects is in response to the generic function.

8. A method for transferring metadata comprising:
receiving, using a processor, a consistent set of user-defined objects for import into a metadata registry; and
importing, using the processor, the set of user-defined objects into the metadata registry, the importing comprising validating the consistency of the set of user-defined objects.

9. The method for transferring metadata of claim 8, wherein validating the consistency comprises:
validating the relationships of all the user-defined objects of the consistent set being imported correspond to relationships between the user-defined objects of the consistent set and at least one of: other user-defined objects of the consistent set or objects of the metadata registry.

10. The method for transferring metadata of claim 8, wherein said importing comprises:
identifying independent user-defined objects;
importing the independent user-defined objects; and
importing dependent user-defined objects dependent on the imported independent user-defined objects.

11. A method for transferring metadata, comprising:
providing a generic function for exporting a metadata object in a consistent set of one or more metadata objects based on an object type of the metadata object.

12. The method for transferring metadata of claim 11, further comprising:
receiving a request to export the metadata object through the generic function;
identifying the consistent set of one or more metadata objects based on the object type of the metadata object; and
exporting the consistent set.

13. The method for transferring metadata of claim 11, wherein said providing the generic function comprises providing an application programming interface for exporting the metadata object.

14. A computer readable medium storing computer readable program code for causing a computer to perform a method for transferring metadata comprising:
separating, using a processor, objects in a metadata registry into system-defined objects and user-defined objects;
identifying, using the processor, a consistent set of the user-defined objects to export based on relationships of the user-defined objects with other objects; and
exporting, using the processor, the consistent set of user-defined objects.

15. A computer readable medium storing computer readable program code for causing a computer to perform a method for transferring metadata comprising:
receiving, using a processor, a consistent set of user-defined objects for import into a metadata registry; and
importing, using the processor, the set of user-defined objects into the metadata registry, the importing comprising validating the consistency of the set of user-defined objects.
